(19) United States
(12) Patent Application Publication
(10) Pub. No.: US 2016/0280343 A1
(43) Pub. Date: Sep. 29, 2016

(54) QUICK MOUNT DRYSUIT PORT SYSTEM

(71) Applicant: Diving Unlimited International, Inc., San Diego, CA (US)

(72) Inventor: Robert T. Stinton, San Diego, CA (US)

(21) Appl. No.: 15/078,296

(22) Filed: Mar. 23, 2016

Related U.S. Application Data
(60) Provisional application No. 62/137,610, filed on Mar. 24, 2015.
(60) Provisional application No. 62/154,002, filed on Apr. 28, 2015.
(60) Provisional application No. 62/294,190, filed on Feb. 11, 2016.

(51) Int. Cl. B63C 11/04; F16L 37/252; F16J 15/06

(52) U.S. Cl. CPC B63C 11/04; F16J 15/06; F16L 37/252; B63C 2011/043

(57) ABSTRACT

A pass-through connection for a wall of a drysuit, comprising, a port comprising, a first, exterior port portion encircling a depending cylindrical flange defining a passage through at least a portion of the port and encircling a longitudinal axis of the passage, the first port portion having an exterior end with a first cylindrical recess that encircles and opens onto the passage, the first port portion having two bosses each extending over a different one of opposing sides of the first cylindrical recess to form an undercut below each boss, the two bosses not extending over the passage, the depending flange extending through a hole in the wall of the drysuit which hole is within a periphery of the first port portion; a second, interior port portion encircling the depending flange and connected to the depending flange to form a fluid tight connection, the first and second port portions having at least one rib on one port portion encircling the passage and at least one corresponding recess on the other port portion to form a labyrinth seal path encircling the passage, with the wall of the drysuit passing through the labyrinth seal path and the port portions being fastened together to clamp the wall between the first and second port portions to prevent the passage of at least water through the labyrinth seal during use of the port; and a wavy spring in the first recess.

### CROSS-REFERENCE TO RELATED APPLICATIONS

The application claims the benefit under 35 U.S.C. §119(e) to Provisional Patent Application No. 62/137,610 filed Mar. 24, 2015, Provisional Patent Application No. 62/154,002 filed Apr. 28, 2015, and Provisional Patent Application No. 62/294,190 filed Feb. 11, 2016, the entire contents of which are incorporated herein by reference.

### BACKGROUND

Drysuits are protective garments worn by divers that isolate the diver from the surrounding water. Drysuits are often used for extended periods of time, with breathing gases provided through connecting hoses that are in fluid communication with portable sources.

Drysuits are made of flexible materials that are gas tight and water tight. For drysuits to work effectively, a gas interlayer is maintained between the diver's skin and the drysuit. A key function of this gas interlayer is the reduction of heat loss to the surrounding water. The drysuit not only isolates the diver from the sounding water it also isolates the diver from necessary services such as liquid body waste elimination. Drysuits need multiple thorough-suit ports to meet the needs of the diver, gas interlayers and equipment worn under the drysuit.

The two most common ports found on a drysuit are for gas inlet valves and exhaust valves. The inlet valve facilitates the addition of gas to the interlayer, while the exhaust valve is used to vent gas from the interlayer. Both valves are critical for proper drysuit operation.

During a diver's descent the gas volume of the interlayer decreases as described by Boyles Law P₁V₁=P₂V₂, and as the ambient pressure increases with the depth of the diver in the water, the volume of the gas interlayer decreases. If this change in volume is not addressed the diver will experience a suit squeeze as the drysuit collapses around the diver's body from the surrounding water pressure. To prevent this collapse from taking place air is added to the interlayers by means of a drysuit inlet valve which is affixed to the drysuit. During ascent, the situation is reversed and the gas in the interlayer expands and this increased volume needs to be vented from the interlayer or the diver will a lose buoyancy control. In addition to these two critical suit port needs, additional ports are used for: body waste management such as p-valves, electrical power for heated undergarments, biometric information, antennas Bluetooth, WiFi, RF acoustic transponders and various sensors.

Currently, drysuit porting FIG. 1 is achieved by using purpose built rubber port/gaskets 1 such as the SI TECH External Valve Port Item No 182222. These rubber ports 1 are permanently affixed to the external surface of the drysuit 2 by means such as adhesives or Radio Frequency welding at and/or between the interlayer surface 3 between the port and drysuit.

Valves such as the SI TECH Inflation Valve Item No 21780 4 are held in place on the grommet 1 with the use of a threaded back nut 5. The installation of the valve 4 and the back nut 5 requires purpose built tools to fit the specific valve 4 and back nut 5. Other valves or devices such as exhaust valves, P-valves etc., also have purpose built, matching rubber ports and tools for installing and removing them. This port 1- threaded blackout 5 approach insures that the devices are securely fastened to the suits; however this approach makes field installation, maintenance, and removal of devices difficult. These port installation and removal procedures are normally carried out at the time of manufacture or later by an authorized service center where the purpose built tools are available.

These installations are difficult, time consuming and require purpose-built tools. There is a need for drysuit ports that are easier to install and remove and that do not require purpose built tools.

### BRIEF SUMMARY

The improved drysuit system disclosed herein is believed to make field maintenance and suit reconfiguration easier at all locations, including the field. A port system is provided having a male connector and female port. The female port may be permanently affixed to a wall of the drysuit using a variety of mechanical approaches such as threads, Radio Frequency welding, sonic welding, interference fit, etc. The connector may be formed on or connected directly to the valves or devices needing to be drysuit mounted. The connector can be formed using common manufacturing methods such as molding, casting, or machining. The installation or removal of a port and connector-equipped valve or device requires only a simple press and quarter turn action. The port and connector system facilitates field replacement and or maintenance of valves and other devices without the need for purpose built tools to engage, rotate and assemble or disassemble various parts. The port and connector system also allows devices to be removed and the port easily capped off with a blanking device, if a device is not needed for the specific dive and the port is not needed. This approach allows the diver to reconfigure the ported devices on their drysuit at the field level and without the need for multiple purpose build tools.

There is thus provided a pass-through connection for a wall of a drysuit, which includes a port on the drysuit. The port includes a first, annular collar on an exterior of the drysuit wall and encircling a depending cylindrical flange that defines a passage through the wall of the drysuit. The first collar encircles a longitudinal axis of the passage and has an exterior end with a first cylindrical recess that encircles and opens onto the passage. The first collar has two bosses each with a side that faces each other. Each side extends over a different but opposing side of the first cylindrical recess to form an undercut below each side. The depending flange extends through a hole in the wall of the drysuit and the periphery of the first collar encloses that hole. Three is a second, annular collar also encircling the depending flange and connected to the depending flange to form a fluid tight connection. The first and second collars have at least one rib on one collar which rib encircles the passage. The collars also have at least one corresponding recess on the other collar which recess also encircles the passage to form a labyrinth seal path encircling the passage. The wall of the drysuit passes through the labyrinth seal path and the first and second collars are fastened together to prevent the passage of at least water through the labyrinth seal during use of the port.

Another embodiment of the pass through connection also advantageously includes a tubular connector having a flange with at least a first tubular portion extending from a first side of the flange. At least one ring seal encircles the first tubular portion and is located to seal against a portion of the passage through the collars during use. The flange on the connector has two mounting lugs each extending from a different one of first and second sides of the flange.

The mounting lugs are sized to fit within the first recess and rotate about the longitudinal axis to place each mounting lug in a different one of the undercuts. The connector, preferably the flange has a first engaging surface configured to mate with a second engaging surface on the port to restrain relative rotation of the connector and port. The mounting lugs may pass between the two sides of the bosses that face each other when the mounting lugs are in a first position parallel to at least one of the sides but the mounting lugs do not pass between the two sides of the bosses that face each other when rotated about the longitudinal axis about 90 degrees. A resilient member is interposed between the port and the connector to resiliently urge the connector out of the passageway and into engagement with the bosses when the lugs are in the undercuts.

In further variations, the resilient connector may include a wavy spring located in the recess.

The two sides of the bosses that face each other are preferably straight at least along a portion passing over the first cylindrical recess, and are also preferably parallel.

There is also provided a pass-through connection for a wall of a drysuit that has a port with first and second port portions. The first, exterior port portion encircles a depending cylindrical flange defining a passage through at least a portion of the port and encircling a longitudinal axis of the passage. The first port also has an exterior end with a first cylindrical recess that encircles and opens onto the passage. Two bosses each extend over a different opposing side of the first cylindrical recess to form an undercut below each boss. The two bosses do not extend over the passage so as to block the connector discussed above. The depending flange extends through a hole in the wall of the drysuit which hole is within a periphery of the first port portion.

The second, interior port portion encircles the depending flange and is configured to be connected to the depending flange to form a fluid tight connection. The first and second port portions have at least one rib on one port portion encircling the passage and at least one corresponding recess on the other port portion to form a labyrinth seal path encircling the passage. The wall of the drysuit passes through the labyrinth seal path when the port portions are fastened together to clamp the wall between the first and second port portions and prevent the passage of at least water through the labyrinth seal during use of the port. A wavy spring is located in the first recess to resiliently urge the tabs against the bosses when the tabs are in the undercuts.

In further variations of this embodiment, the pass through connection for a drysuit includes a tubular connector having a flange with at least a first tubular portion extending from a first side of the flange. The first tubular portion may have at least one ring seal encircling the first tubular portion and located to seal against a portion of the port during use. The flange may have two mounting lugs each extending from a different one of opposing first and second sides of the flange with the mounting lugs sized to snugly fit within the first recess and rotate about the longitudinal axis to place each mounting lug in a different one of the undercuts.

Advantageously, at least one of the undercuts is semicircular and at least one and preferably both mounting tabs have a semicircular portion configured to fit into the semicircular undercuts. The flange may have a first engaging surface configured to mate with a second engaging surface on the port to restrain relative rotation of the connector and port. The first engaging surface is preferably an offset shoulder on at least one of the mounting tabs. The bosses preferably have sides that face each other and the second engaging surface is formed on at least one of those sides. The connector may have has a second tubular portion extending from a second side of the flange that is opposite the first side of the flange. The depending flange is preferably connected to the second port portion to form a fluid tight connection. The at least one seal preferably comprises at least two, O-ring seals that seal against the depending flange. The O-ring seals and labyrinth seal are preferably substantially fluid tight.

The above parts of the pass-through connection and connector may be provided already installed on a drysuit wall, or they may be provided separately in an unassembled condition, ready for a user or manufacturer to assemble the parts and form the port, and to connect the various devices to the connector.

There is also provided a method of providing a pass through connection for a wall of a drysuit having a port the clamps to opposing sides of the wall to form a fluid tight seal, where the port has a passageway therethrough and two bosses on opposing sides of the passageway. Each boss may have an undercut forming part of an annular recess encircling and forming part of the passageway. The method includes the step of inserting a first portion of a connector through the passageway where the passageway has a longitudinal axis. The method may include aligning mounting tabs on the connector to pass between the two bosses. The method includes the step of inserting the mounting tabs into the space between the two bosses a distance sufficient to allow rotation of each mounting tab into a different one of the undercuts. The method then rotates the connector and mounting tabs about the longitudinal to position each mounting tabs in a different one of the undercuts. The method also preferably includes the step of restraining the connector from rotating relative to the port.

In further variations, the restraining step includes positioning a first engaging surface on the connector to engage a second engaging surface on the port. Further the restraining step may be provided by engaging a spring-loaded detent mechanism. The positioning step may also include moving at least one of the connector or port along the longitudinal axis. The method may further include the method counterparts of the assembling and using the various parts described herein.

### BRIEF DESCRIPTION OF THE DRAWINGS

These and other features and advantages of the hood and face mask will be better understood by reference to the following drawings in which like numbers refer to like parts throughout, and in which:

FIG. 1 is a sectional view of a prior art valve installation in a drysuit;

FIG. 2 is an exploded perspective view of an improved design for a port and a plug connector for use with the port;

FIG. 3 is a perspective view of a male plug connector shown in FIG. 2;

FIG. 4 is a cross-sectional view of the plug connector of FIG. 3 taken along section 4-4 of FIG. 3;

FIG. 5 is an upper perspective view of the female port mounted on a portion of a drysuit;

FIG. 6 is a cross-sectional view of the port of FIG. 5 taken along section 6-6 of FIG. 5

FIG. 7 is an upper perspective view of a male plug connector inserted into a female port with the male plug connector in an unlocked position;

FIG. 8 is a cross-sectional view of FIG. 7 taken along section 8-8 of FIG. 7;

FIG. 9 is an upper perspective view of a male plug connector inserted into a female port with the male plug connector in a locked position; and

FIG. 10 is a cross-sectional view of FIG. 9 taken along section 10-10 of FIG. 9

FIG. 11 is a perspective view of the connector of FIG. 9 with mounting lugs;

FIG. 12 is a sectional view taken along section 10-10 of FIG. 9 where the connector comprises a P-valve;

FIG. 13 is a sectional view taken along section 10-10 of FIG. 9 where the connector comprises an inlet valve; and

FIG. 13 is a sectional view taken along section 10-1- of FIG. 9 where the connector comprises an exhaust valve.

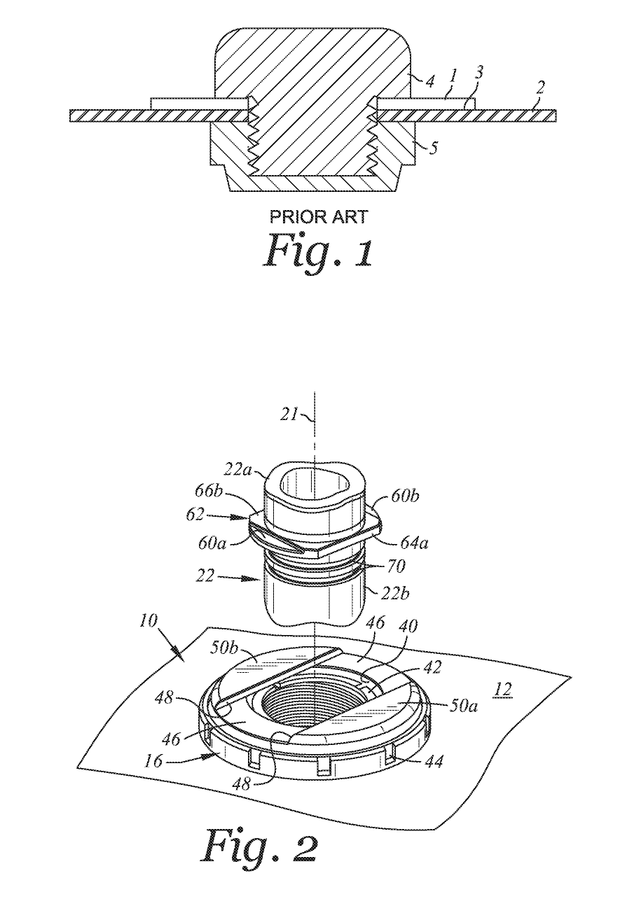

### DETAILED DESCRIPTION

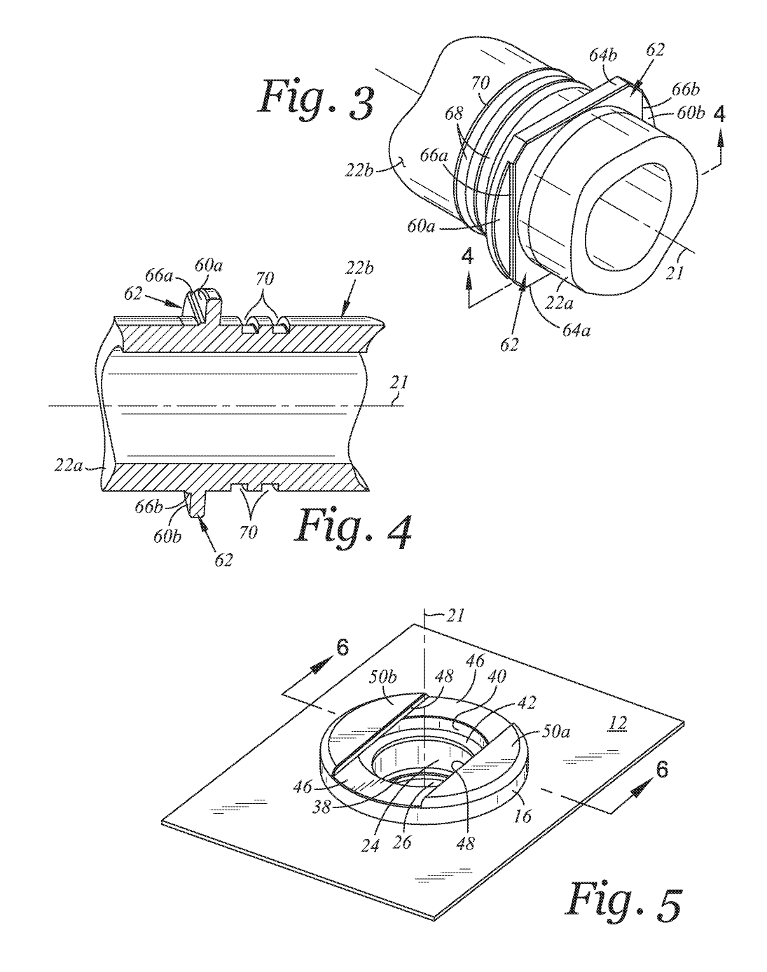

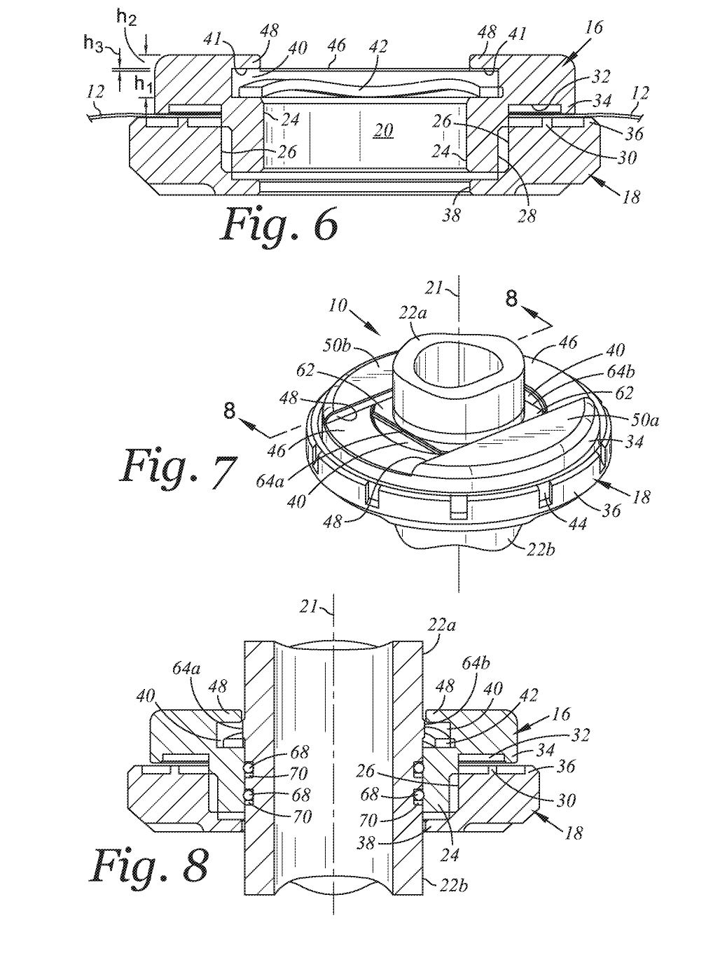

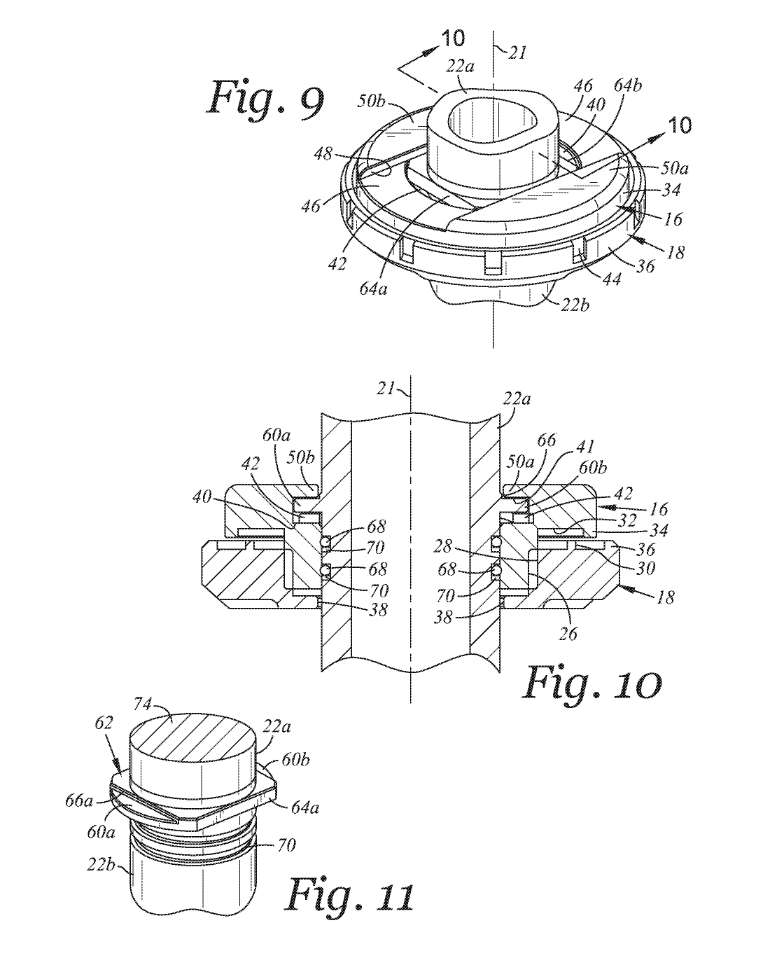

Referring to FIGS. 2-10, a port and connector system is provided having a port 10 extending through a wall 12 of a drysuit 14. The port 10 may have two parts, an exterior port part 16 and an interior port part 18, preferably comprising male and female collar parts mated together to form the port 10 having a hole or passage 20 extending through the wall 12 of the drysuit. As used herein, interior and exterior, inside and outside, refer to relative locations inside the drysuit during use or outside the drysuit during use of the drysuit 14.

Referring to FIGS. 2, 5 and 6, the port 10 is fixed to the wall 12 of the dry suit 14 to form a fluid tight connection through the wall 12. As used herein a fluid tight seal prevents passage of water and gas at the temperatures and pressures to which the drysuit is subjected during use, with substantially no leakage at a pressure of over 1000 psi. The connection of the port 10 to the wall 12 is preferably permanent to more securely form a hole or passage 20 or hole through the drysuit 14 and to protect that passage 20 from damage during use. A male connector 22 mates with the port 10 through the passage 20 during use, as described later. The passage 20 has longitudinal axis 21 along which the male connector 22 extends as it passes through the passage 20. The relative terms inward, outward refer to directions toward and away from longitudinal axis 21.

The exterior port portion 16 forms a locking body that engages the interior portion 18 that acts as a back plate on the inside of the drysuit. The two port parts 16, 18 clamp together on opposing sides of the wall 12 to form a fluid tight seal with the wall between those two clamped parts. The port parts 16, 18 are preferably annular shaped collars with an interior wall of one of the collars defining and encircling the passage 20. The interior and exterior portions 16, 18 are preferably installed at the time the drysuit is manufactured. Advantageously, the exterior port part 16 has a depending flange 24 such as a cylindrical tube that is configured to mate with a conforming recess or opening 26 in the interior part 18. Preferably, the port part 16 comprises an annular collar part 16 with flange 24 depending from the collar part to form the passage 20. The interior port part 18 preferably also comprises an annular collar having a wall defining a central opening 26 which is configured to engage and connect to the depending flange 24. The depending flange 24 and conforming opening 26 are preferably both cylindrical surfaces having mating engaging surfaces such as threads 28 locating thereon.

The parts 16, 18 are advantageously permanently fastened together by adhesive, melting, or other affixing mechanisms. Alternatively, interlocking surfaces, interference fits, adhesives, sonic welding or melting of contacting surfaces may be used to fasten the mating portions 24, 26 together. The connecting method or mechanism preferably provides a fluid tight seal. The port portions 24, 26 may be made of any material suitable for use with drysuit 14, including metals and plastics. Plastics are preferred so the parts may be molded to achieve a lower cost to produce the parts.

The port may be sealed to the wall 12 of the drysuit by various ways, including the use of sealing adhesives between the port and drysuit, melting through the application of heat or vibration. Advantageously though one of the opposing parts 16, 18 has at least one circular rib or flange 30 encircling the passage 20 and the other of the opposing parts 16, 18 has a correspondingly sized recess 32 with the circular rib and mating recess sized to trap the wall 12 between them and cause the wall to form a tortuous path and form a labyrinth seal.

Advantageously, flexible, sealing adhesives may be applied to opposing sides of the wall 12 to further connect the wall to the parts 16, 18 and to provide a fluid tight seal. In the depicted embodiment the seal is a face seal in the plane of the drysuit at the location where the port is placed and is formed on radially extending flanges of the port parts 16, 18, with the recess 32 formed by the wall defining the passage 20 and a peripheral flange 34 on male port part 16. The female port part 18 has circular rib 30 extending toward recess 32 and further has a peripheral flange 36 encircling the passage 20 and facing the same direction as rib 30 so as to form two spaced apart, circular ribs or flanges. The circular peripheral flange 34 fits between the circular flanges 30, 36 with the wall 12 of the drysuit forced by the flanges into a tortuous path to help provide a fluid tight seal and to help provide a secure connection of the port to the drysuit. Has three interlocking rings and advantageously from two to ten interlocking rings are used, with each ring altering the direction of the tortuous path through the mating parts 16, 18. The depicted labyrinth seal. Other sealing connections between the parts 16, 18 of the port and the drysuit may be used, including an axially oriented seal along the axis of passage 20.

Advantageously, the female port part 18 has an inwardly extending stop flange 36 located to limit the position of the male part 16. The stop flange encircles the passage 20 and may form an interior portion of the passage 20. The length of the depending flange 24 and the location of the stop flange 38 are selected to limit the relative motion of the mating port parts 16, 18. Advantageously, the stop flange 38 prevents the mating flanges 30, 34, 36 from cutting through the wall 12 of the drysuit during assembly, while allowing a sufficient compression of the wall 12 to form a fluid tight seal, a secure connection, or both.

The outer port part 16 advantageously has a recess 40 encircling the outer periphery of the passage 20 adjacent the outer surface of the outer port part 16. The recess 40 preferably comprises a cylindrical recess with a circular periphery or sidewall and a radially extending bottom and top to form a generally C-shaped cross-section that opens inward toward the longitudinal axis 21 of the passage 20. The recess 40 has a height H measured parallel to the longitudinal axis 21. The recess 40 is sized to receive and retain a resilient member 42 such as a wavy spring washer. The wavy washer 42 is annular in shape, preferably with a larger inner diameter than the passage 20 and an outer diameter that is smaller than the outer than the diameter an inward and slightly larger than the sidewall of the recess 40 so the washer 42 is retained by the recess. For ease of manufacture or assembly, the corners of the parts 16, 18 may be rounded or chamfered.

Referring to FIGS. 2 and 7, the outer periphery of the inner port part 18 is preferably larger in diameter than the outer port part 16, so that the periphery of outer part 16 fits inside the inner part 18. The relative sizes could be reversed with the outer part 16 larger in diameter than the inner part 18. The periphery of the larger diameter part, here inner port part 18, has a plurality of notches 44 around the periphery of the port part 16. The notches 44 are shown as rectangular recesses extending radially inward from the outer periphery of the edge of the port part 16, with the recess extending parallel to axis 21 and opening onto the axial aligned edge of the peripheral flange 36. The recesses 44 provide gripping surfaces for manual or wrenching rotation of the port part 18 relative to port part 20.

The exterior surface of the port part 16 that is orthogonal to axis 21 has a keyway 46 formed in it. The keyway advantageously takes the form of a flat bottomed, shallow depth slot 46 formed in the generally flat top of the outer port part 16. The slot 46 is wide enough pass on opposing sides of the passage 20 and has sidewalls 48. The slot 46 is not wide enough to extend to the outer diameter of the recess 40 so the sidewall and bottom of recess 40 opens onto the bottom of slot 46 while two opposing sides of the recess remain and undercut a portion of the exterior surface of the port 10, forming two ledges each of which extends across a chord of the recess 40. The keyway or slot 46 is shown as a wide slot with a flat bottom and short, parallel sidewalls 48 having a height h parallel to the axis 21. Viewed a slightly different way, two semi-circular shaped bosses 50a, 50b on opposing sides of the outer port part 16 have parallel and spaced apart sidewalls 48 that pass on opposing sides of the passage 20 to form a shallow slot 46.

The bottom of the slot 46 advantageously passes through a portion of the recess 40 so the middle of the bosses 50a, 50b form a slight semi-circular recess in the bottom of each boss facing along axis 21 toward the mating port part 18. The bosses 50a, 50b each overlap a portion of the recess 40, or the recess 40 extends under and undercuts a portion of the bosses 50a, 50b to form the described ledges. The bosses 50 need not be semi-circular in shape but they advantageously have the parallel sidewalls 48 that face each other on opposing sides of the passage 20 to overlap two opposing portions of the recess 40 while allowing access to two other opposing portions of the recess 40. Thus, as seen in FIG. 2, two opposing sides of the recess 40 open onto the bottom of the slot 46 while two other sides of the recess 40 remain covered by one of the bosses 50a, 50b to form two, semi-circular, undercut segments of the recess 40. Depending on the width of the slot 46 and corresponding spacing of sidewalls 48, and depending on the diameter of recess 40 and passage 20, the size of the semi-circular segments of the recess 40 may vary.

The male connector 22 has connecting lugs 60 extending outward from a keying boss 62 on the connector and axis 21. Preferably the keying boss 62 and connecting lugs 60 both extend radially outward and in a plane orthogonal to axis 21. The connecting lugs help 60 lock the connector 22 to the port 10 and may be referred to as locking features. The keying boss 62 is advantageously configured to fit in the slot 46 that forms a keyway in the port 10. The keying boss 62 is advantageously a quadrilateral and preferably a square with two opposing, guiding sides 64a, 64b that are spaced apart a distance slightly smaller than the distance between sidewalls 48, with the cylindrical body 8 passing through the boss 62, so the boss effectively forms a flange on the connector 22. The guiding sides 64 and sidewalls 48 are preferably parallel to axis 21. The connecting lugs 60a, 60b each extend from different ones of the other two, opposing sides of the keying boss 62. The connecting lugs 60a, 60b may be slightly thinner in the axial direction than the keying boss 62 to form a locking offset 66 at the juncture of each connecting lug 60 with the boss 62. The locking offsets 66 are preferably a pair of flat surfaces parallel to axis 21 and perpendicular to guiding sides 64 extending along the length of the juncture with the lug 60. The connecting lugs 60 preferably have a curved periphery that is preferably semi-circular in shape with a diameter slightly smaller than the diameter of recess 40 in port part 16.

Referring to FIGS. 2-4, 8 and 10, the connector 22 has first and second tubular portions passing through the boss 62 and extending in opposing directions from that boss. The first tubular portion 22a extends toward the exterior or outside of the drysuit during use. The first connector portion 22a preferably has a generally cylindrical outer surface for at least a short distance from the boss 64. At least one and preferably a few ring seals 68 encircle the inner portion of the first connector 22a, with two ring seals being preferred. Advantageously the ring seals 68 comprise O-ring seals and are seated in grooves or glands 70 formed in the outer surface of the first connector portion 22a, preferably in a plane orthogonal to axis 21. The remainder of the first connector portion 22a will vary in configuration depending on the specific use of the equipment using the connector 22. The second connector portion 22b extends on the inside of the drysuit during use and may extend along the drysuit surface or away from the drysuit, depending on the equipment using the connector 22. The second connector portion 22b is tubular for at least the portion adjacent the boss 62, with the distal portion varying depending on the specific use of the equipment using the connector portion 22.

Referring to FIGS. 2, 7, 8 and 10, in use, the manufacturer or user passes the second portion 22a and any associated equipment through the passage 20 in port 10 which is already installed in the drysuit. The connector 22 is rotated so that the mounting lugs 60a, 60b are aligned with the length of the slot 46, with guiding sides 64 aligned with the sidewalls 48 of the slot and the mounting lugs 60 aligned with passage 20. One or both of the connector 22 and port 10 are moved until the mounting lugs 60 push the wavy washer 42 against the bottom of the recess 40, and with the guiding sides 64 nested between opposing sidewalls 48. At this point, at least one and preferably both of the ring seals 68 advantageously contact the sidewall of depending flange 24 encircling the passage 20 so the ring seals 68 may form a fluid tight seal with the flange 24. The parts 10, 20 are moved together until the mounting lugs 60a, 60b may fit underneath the undercut portion of bosses 50 at which point one or both of the connector 22 and port 10 are rotated so the lugs 60a, 60b fit inside the recess 40 underneath the lugs 50a, 50b. The parts are configured to allow this fit and rotation. Additionally, the parts 10, 20 must be moved toward each other until the locking offsets 66 are below the bottom of the bosses 50 and can rotate into the portion of the recess 40 covered by or formed by those bosses. The relative rotation of connector 22 and port 10 align the locking offsets 66 with the sides 48. The parts are then released and either the installer or the wavy spring washer 42 moves the locking offset 66 away from the port 10 so the offset 66 fits between the sidewalls 48 which prevent relative rotation of the connector and port. In this position, the seals 68 form a fluid tight seal with the port 10. The wavy spring washer 42 resiliently urges the offsets 66 into locking engagement with the sidewalls 48 to prevent rotation about axis 21.

The resulting coupling of connector 22 to port 10 allows the tubular passage formed by tubular portions 22a, 22b to pass various items through the connector and port. To uncouple the parts, one or both of the port 10 and connector 22 are moved toward each other until the locking offsets 66 are below the bottom of the bosses 50 and can rotate into the portion of the recess 40 covered by or formed by those bosses. One or both parts 10, 22 are then rotated until the mounting lugs 66 are no longer blocked by the bosses 50a, 50b, at which point the connector 22 and/or port 10 may be disengaged and removed along axis 21 or otherwise. The tubular passage through connector parts 22a, 22b thus provides a conduit for fluids and/or wires to pass through the male connector 22, port 10 and wall 12 of the drysuit 14. The two portions 22a, 22b of the connector 22 can be formed to meet the specific application such as air inlet and exhaust valve, P-valve valves, etc.

Described in slightly different terms, the bosses 50a, 50b form two raised detainer bodies on opposing sides of the keyway 46. The keyway 46 accepts the mounting lugs 60 on the connector 22, which lugs fit into the cylindrical cavity 40 which contains wave spring 42. The underside of the two detainer bodies 50a, 50b on opposing sides of the keyway 46 form undercuts forming detainer locking channels which are positioned 90° off the lateral axis extending along the length of the keyway in a plane orthogonal to axis 21.

The key bosses 60a, 60b of the connector 22 are aligned with the keyway 46 of the female port 10. The connector 22 is pressed down and into the cylindrical cavity 40, compressing the wave spring 42. When the wave spring is compressed the male key bosses 60a, 60b can be rotated 360° about axis 21 in the cylindrical cavity 40. The underside of the two raised detainer bodies 50a, 50b are equipped with undercuts forming locking channels which are positioned 90° off the laterally aligned, longitudinal axis of keyway 46. When the locking lugs 60a, 60b on opposing sides of the keying boss 62 are lined up with the locking channels under the detainer bodies and downward pressure is released on the connector 22, then the wave spring 42 presses the locking lugs 60a, 60b into the locking channels under the detainer bodies 50a, 50b. This action locks the male connector element 22 so the device is locked into position. The O-rings 68 on the male connector element 22 form a pressure tight seal with the locking body O-ring sealing surface 24 forming the passage 20.

The removal of the port 10 and connector device 22 requires simply applying downward pressure on the connector device 22 so the keying bosses or connecting lugs 50a, 50b compressing the wave spring 42, thereby allowing the key boss 62 and its locking surfaces 66 to rotate freely in the cylinder cavity 40. When the keying boss 62 is aligned with the keyway 46 and sidewalls 48, the male connector element 22 can be removed.

The locking offset 66 cooperates with the sidewalls 48 for form a releasable locking mechanism that is in simple terms a spring loaded detent mechanism, with the offset portion of the keying boss 50 (and locking offsets 66) acting as a locking protrusion that is resiliently urged by wavy spring washer 42 into the detent formed by the space between sidewalls 48. Other spring-detent configurations may be used to restrain relative rotation of parts 10, 22, with the detent being on either the connector 22 or port 10, and the engaging projection being on the other of the connector or port. The mating parts may also be viewed as a spring loaded latch mechanism where the raised portion 68 of the keying boss 62 is a latch resiliently urged by wavy spring washer 42 into the catch or latch engaging member formed by sidewalls 48. Other resilient latch mechanisms may be used to releasably engage and prevent relative rotation of connector 22 and port 10, with the latch on one of the connector or port and the catch on the other of the connector or port.

The seals 68 are preferably O-ring seals, but other seal configurations may be used, including D-ring seals and other ring seals with different cross-sectional shapes. Further, while the seals 68 are preferably on the connector 22, one or more seals may be located on the portions of the port 10 facing and encircling the first portion 22a of connector 22.

If a particular port 10 is not being used on a particular dive then the port may be blocked by closing off the first connector portion 22a. FIG. 11 shows one embodiment where the first connector portion extends a short distance from flange 62 and has a closed end 74 to prevent water from entering and passing through the connector. A textured surface 76 may be provided on the exterior of the first connector portion 22a adjacent flange 62 to make it easier to manually grip and manipulate the connector 22. Likewise, the second connector portion may extend a short distance past the seal rings 68 and also have a closed end. Other portions of the connector 22 may be plugged or blocked between the ends 74.

The parts forming the first port portion 16 and second port portion 18 may be provided separately in a kit without being connected to the wall 12 of the drysuit 14. The kit may include the connector 22 with the first portion 22a connected to a diving related device, or unconnected to any device. The kit may include the connector 22 with blocked ends or with a blocked or non-existent flow passage.

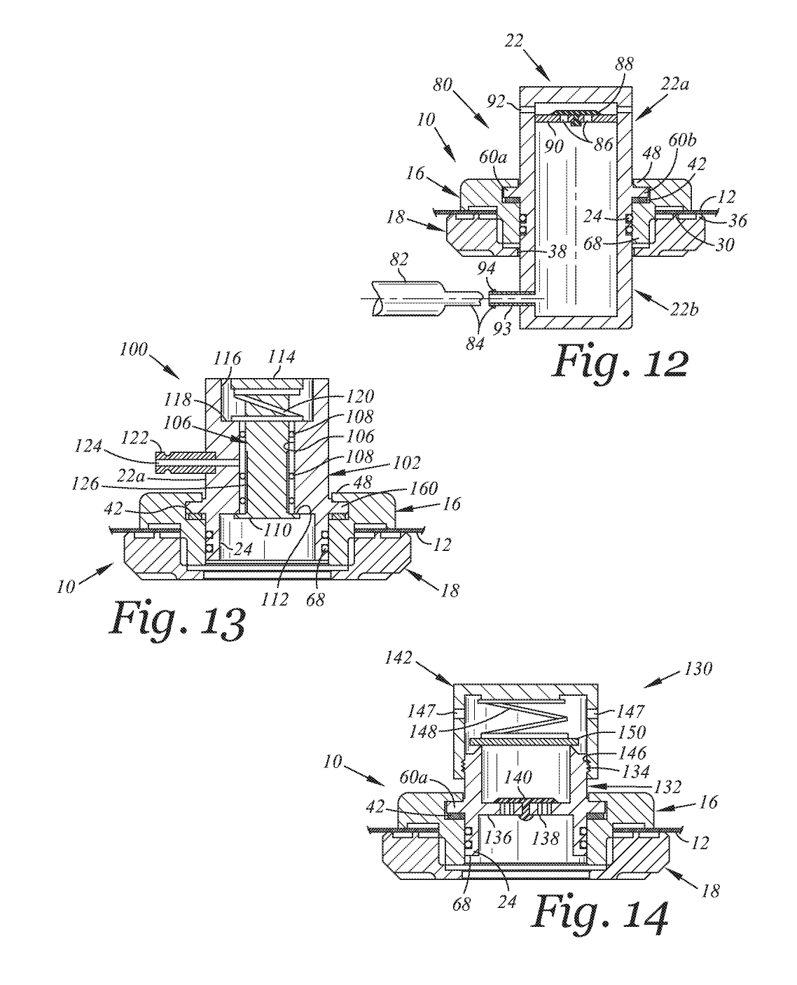

Referring to FIG. 12, the connector 22 is shown forming a P-valve or Pee-valve 80, that has an input connector 82 configured to mate with the genitalia of the diver, preferably in a fluid tight manner to pass urine. The input connector 82 is shown as a condom for mating with the outside of a penis of a male diver. The input connector 82 is connected to a urinary tube 84 of sufficient length to extend to the port 10 and second portion of male connector 22b which extends through the port and into the dry suit during use. The depicted male connector is shown as an elongated tube with lugs 60a, 60b extending outward from a middle portion of the connector 22 to mate with corresponding portions of the first part 16 of port 10. The connector 22b has O-ring seals 68 encircling the tube and sealing against the flange 24 of the exterior part 16 of the port. The seals 68 are shown in glands or grooves in the exterior wall of the tubular connector 20. The urinary tube 84 connects to an interior portion 22b of the connector.

The exterior portion 22a of the connector has at least one and preferably a plurality of ports 86 blocked by a valve 88 that opens when the pressure from urine in the connector opens the valve. Suitable check valves and pressure balance valves are known in the art and are provided in the urine tube 84 or the P-valve 80 as desired. In the depicted embodiment, the exterior end 22a of the P-valve 80 has a perforated disk 90 through which a plurality of ports 86 extend with an elastomeric umbrella valve having a stem connected to the disk 90 so the umbrella valve 88 blocks the ports 86. Pressure from the urine in the P-valve opens the umbrella valve 88 allowing the urine to flow out passages 92 through the wall of the tubular P-valve 80 and into the surrounding water or a portable container (not shown).

The lugs 60a, 60b allow the P-valve 80 to be readily connected or disconnected to mate with corresponding portions of the first part 16 of port 10 as desired. The interior end 22b of the P-valve 80 advantageously has a male fitting 93 with one or two barbs 94, with the fitting extending therefrom and sized so the urinary tube 84 passes over the outside of the barbed fitting to provide a releasable, fluid tight connection. As desired, the end of the urinary tube 84 may be clamped to the male fitting. Other connections to the connector 22 may be used. The male fitting 93 may be added after the P-valve lugs 60 are engaged with the port 10, or the P-valve 80 may be canted to pass the fitting and bottom of the P-valve through the port 10.

Referring to FIG. 13, the connector 22 may include an inlet valve 100 on the outer portion 22a of the connector. The inlet valve 100 is shown in a directional control valve, basically a two position, sliding spool valve. The inlet valve 100 has valve housing 102 with lugs 60a, 60b extending outward from an exterior of the housing 102, adjacent a lower end of the body to releasably connect to the corresponding portions of the first part 16 of port 10 as described herein. The inlet valve has seals 68 on depending flange 24 or other portions of the housing 102 of the inlet valve 100. The valve housing 102 has an internal passage 104 passing which passage is configured to receive reciprocating spool valve body 106. The passage 104 and spool valve body 106 are typically cylindrical, with a plurality of ring seals 108 (preferably O-ring seals) encircling the longitudinal axis of the spool valve 104 and sealing against the inner walls of the passage 104 and the outer walls of the spool valve 106 to form a fluid tight seal along the length of the reciprocating spool valve. The inner end of the spool valve body 106 has a valve seal 110 that abuts valve seat 112 to prevent flow through the passage 104. In FIG. 13 the valve seal and valve seat are shown as abutting flat surfaces that are horizontal and that is for ease of illustration. Typically the valve seal 100 and seat 112 are mating conical surfaces. In the depicted embodiment, a gasket may be interposed between the mating surfaces of the seal 110 and seat 112 to assist fluid tight sealing.

An outer end of the spool valve body 104 has an externally accessible head 114 that is manually accessible from outside the suite to actuate the spool valve body 104. The head 114 is shown as a disk fastened to the outer end of the spool valve body 104. The head 1114 is located in a recess 116 of the housing 102 that encircles the passage 1004 and that is larger than the passage 104 so that a bottom 118 of the recess 116 forms a shoulder on what amounts to a stepped, cylindrical passage through the housing 102. A coil spring 120 encircles the spool valve body 106 and is located between the head 100 and bottom 118 so as to resiliently urge the head 100 and spool valve body 106 out of the passage 104 and into a first closed position.

An air inlet fitting 122 has a passageway 124 that is in fluid communication with the valve passage 104. The fitting 122 is shown as a male, quick-disconnect fitting extending laterally from the housing 102, orthogonal to the longitudinal axis of the reciprocating spool valve body 106 and valve passage 104. During use, a supply of pressurized air is connected to the inlet fitting 122. The air inlet passage 124 is typically restricted by a small diameter passage or by an orifice of selected diameter so as to limit the air flow into the and through the inlet valve 100.

The spool valve body 106 reciprocates between the first, closed position shown in FIG. 13 and a second, open position (not shown) where the user pushes the head 114 and overcomes the force of spring 120 to move the spool valve seal 110 against away from the seat 112 to allow air from inlet 122 to flow through passage 24 and into the dry suit. The spring 120 urges the head 114 into the closed position to stop flow through the valve 100 when the user stops pushing against the head 114. Depending on the location of seals 108, bypass grooves 126 or passages in the valve body 106 may be used to allow inlet air to pass selected seals 108 between the air inlet passage 124 and the valve seat 112 so as to flow into the suit during actuation of the valve 100 as the valve moves to the second, open position. The depicted valve 100 exhausts the inlet air generally along the longitudinal axis of the spool valve body 106, and as desired, a pressure enclosure may be located below the valve seal 100 and seat 112 and extend beyond the interior part 18 of the port 10 in order to vent the air inside the suit in a direction laterally to that axis

Referring to FIG. 14, the connector 22 may comprise an exhaust valve 130. The depicted exhaust valve is adjustable to allow a continual exhaust of gas through the valve 130 at an adjustable flow rate. The exhaust valve 130 has a housing 132 with lugs 60a, 60b extending outward to mate with corresponding portions of the first part 16 of port 10. A depending flange 24 on the housing 132 has exterior sealing rings 68 to seal against the port 10. The housing 132 has an exterior portion 22a in the form of a short tube with threads 134 at or adjacent to the outer or distal end of the housing. The inside of the tube has a recess with a bottom 136 having one or more air passages 138 extending through the bottom and in fluid communication with the inside of the dry suit through the port 10. An elastomeric umbrella valve 136 is connected to the bottom 136 so as to cover the air passages 138. When the pressure on the inside of the suit exceeds the pressure on the outside of the umbrella valve 140 the valve uncovers the air passages 138 to allow air to flow past the umbrella valve.

A cap 142 having a skirt 144 with internal threads 146 fits over the outer end of the housing 134 so threads 146 mate with threads 134 on the outside of the housing. Rotation of cap 142 relative to housing 134 moves the cap closer to and further from the housing 132. The cap has at least one and preferably a plurality of holes or vent passages 147 passing through the skirt 144. The inside of the cap 142 has a central boss encircled by a valve spring 148 around which is shown as a compression, coil spring.

A valve seat 150 rests against the outer end of the tubular housing with the spring 148 interposed between the cap 142 and valve seat 150 to resiliently urge the valve seat against the top of the housing 134. As depicted, the valve seat 150 is a flat disk abutting the outer end of the tubular housing 134 to form a seal. The outer end of the tubular housing 134 is shown with a tapered exterior or outer surface so that a narrow ring or annular area abuts the valve seat 150.

Rotating the cap 142 adjusts the compression of the valve spring 148 to adjust the pressure at which the valve seat 150 opens.

During use, the umbrella valve 140 closes the passages 138 to prevent air passing through the valve 130 and port 10 when the pressure in the housing 134 is greater than the pressure inside the suit. By adjusting the compression on valve spring 148, the pressure inside the housing 134 may be adjusted passage by adjusting the spring force resiliently urging the valve seat 150 against the end of the housing 134. When pressure inside the dry suit opens the umbrella valve 140 and valve seat 150, air flows through passages 138, through the valve seat 150 and out passages 147 in cap 142. The user rotates the cap 142 relative to port 10 and housing 134 until the desired flow of air from the valve 130 is determined. The umbrella valve 140 and valve seat 150 provide a redundant seal against water entering the suit through the valve 130.

The above description is given by way of example, and not limitation. Given the above disclosure, one skilled in the art could devise variations that are within the scope and spirit of the invention disclosed herein, including various ways of releasably restraining the relative rotation of the connector 22 an port 10, and of sealing the parts of the port 10 to at least one and preferably both opposing sides of the wall 12 of drysuit 14. Likewise, various inlet valve, outlet valve, P-valves, and other valves and fittings may use the lugs 60 mating with the port 10.

Further, the various features of the embodiments disclosed herein can be used alone, or in varying combinations with each other and are not intended to be limited to the specific combination described herein. Thus, the scope of the claims is not to be limited by the illustrated embodiments

What is claimed is:

1. A pass-through connection for a wall of a drysuit, comprising:
a port comprising:
a first, exterior port portion encircling a depending cylindrical flange defining a passage through at least a portion of the port and encircling a longitudinal axis of the passage, the first port portion having an exterior end with a first cylindrical recess that encircles and opens onto the passage, the first port portion having two bosses each extending over a different one of opposing sides of the first cylindrical recess to form an undercut below each boss, the two bosses not extending over the passage, the depending flange extending through a hole in the wall of the drysuit which hole is within a periphery of the first port portion;
a second, interior port portion encircling the depending flange and connected to the depending flange to form a fluid tight connection, the first and second port portions having at least one rib on one port portion encircling the passage and at least one corresponding recess on the other port portion to form a labyrinth seal path encircling the passage, with the wall of the drysuit passing through the labyrinth seal path and the port portions being fastened together to clamp the wall between the first and second port portions to prevent the passage of at least water through the labyrinth seal during use of the port; and
a wavy spring in the first recess.

2. The pass through connection for a drysuit of claim 1, further comprising:
a tubular connector having a flange with at least a first tubular portion extending from a first side of the flange, the first tubular portion having at least one ring seal encircling the first tubular portion and located to seal against a portion of the port during use, the flange having two mounting lugs each extending from a different one of opposing first and second sides of the flange, the mounting lugs sized to snugly fit within the first recess and rotate about the longitudinal axis to place each mounting lug in a different one of the undercuts, the flange having a first engaging surface mating with a second engaging surface on the port to restrain relative rotation of the connector and port.

3. The pass through connection for a drysuit of claim 2, wherein at least one of the undercuts is semicircular and the mounting tabs have a semicircular portion configured to fit into the semicircular undercuts.

4. The pass through connection for a drysuit of claim 2, wherein the first engaging surface is an offset shoulder on at least one of the mounting tabs and wherein the bosses have sides that face each other and the second engaging surface is at least one of those sides.

5. The pass through connection for a drysuit of claim 3, wherein the first engaging surface is an offset shoulder on at least one of the mounting tabs and wherein the bosses have sides that face each other and the second engaging surface is at least one of those sides.

6. The pass through connection for a drysuit of claim 2, wherein the connector has a second tubular portion extending from a second side of the flange that is opposite the first side of the flange.

7. The pass through connection for a drysuit of claim 5, wherein the connector has a second tubular portion extending from a second side of the flange that is opposite the first side of the flange.

8. The pass through connection for a drysuit of claim 2, wherein the depending flange is connected to the second port portion to form a fluid tight connection, and wherein the at least one seal comprises at least two, O-ring seals that seal against the depending flange, and wherein the O-ring seals and labyrinth seal are substantially fluid tight.

9. The pass through connection for a drysuit of claim 7, wherein the depending flange is connected to the second port portion to form a fluid tight connection, and wherein the at least one seal comprises at least two, O-ring seals that seal against the depending flange, and wherein the O-ring seals and labyrinth seal are substantially fluid tight.

10. The pass through connection for a drysuit of claim 2, wherein the tubular connector is part of an inlet valve, an outlet valve or a P-valve.

11. A pass-through connection for a wall of a drysuit, comprising:
a port comprising:
a first, annular collar on an exterior of the drysuit wall and encircling a depending cylindrical flange defining a passage through the wall, the first collar encircling a longitudinal axis of the passage, the first collar having an exterior end with a first cylindrical recess that encircles and opens onto the passage, the first collar having two bosses each with a side that faces each other, side extending over a different but opposing side of the first cylindrical recess to form an undercut below each side, the depending flange extending through a hole in the wall of the drysuit which hole is within a periphery of the first collar;
a second, annular collar encircling the depending flange and connected to the depending flange to form a fluid tight connection, the first and second collars having at least one rib on one collar which rib encircles the passage and further having at least one corresponding recess on the other collar which recess also encircles the passage to form a labyrinth seal path encircling the passage, with the wall of the drysuit passing through the labyrinth seal path, the first and second collars fastened together to prevent the passage of at least water through the labyrinth seal during use of the port;
a tubular connector having a flange with at least a first tubular portion extending from a first side of the flange and at least one ring seal encircling the first tubular portion and located to seal against a portion of the passage through the collars during use, the flange having two mounting lugs each extending from a different one of opposing first and second sides of the flange, the mounting lugs being sized to fit within the first recess and rotate about the longitudinal axis to place each mounting lug in a different one of the undercuts, the flange having a first engaging surface configured to mate with a second engaging surface on the port to restrain relative rotation of the connector and port, the mounting lugs passing between the two sides of the bosses that face each other when the mounting lugs are in a first position parallel to at least one of the sides with the mounting lugs not passing between the two sides of the bosses that face each other when rotated about the longitudinal axis about 90 degrees; and
a resilient member interposed between the port and the connector to resiliently urge the connector out of the passageway.

12. The pass through connection for a drysuit of claim 11, wherein the resilient connector comprises a wavy spring in the recess, and wherein the two sides of the bosses that face each other are straight along a portion passing over the first cylindrical recess, and are parallel.

13. The pass through connection for a drysuit of claim 11, wherein the tubular connector is part of an inlet valve, an outlet valve or a P-valve.

14. A method of providing a pass through connection for a wall of a drysuit having a port the clamps to opposing sides of the wall to form a fluid tight seal, the port having a passageway therethrough and two bosses on opposing sides of the passageway, each boss having an undercut forming part of an annular recess encircling and forming part of the passageway, comprising the steps of:
inserting a first portion of a connector through the passageway, the passageway having a longitudinal axis;
aligning mounting tabs on the connector to pass between the two bosses;
inserting the mounting tabs into the space between the two bosses a distance sufficient to allow rotation of each mounting tab into a different one of the undercuts;
rotating the connector and mounting tabs about the longitudinal to position each mounting tabs in a different one of the undercuts; and
restraining the connector from rotating relative to the port.

15. The method of claim 14, wherein the restraining step comprises positioning a first engaging surface on the connector to engage a second engaging surface on the port.

16. The method of claim 15, wherein the positioning step further includes moving at least one of the connector or port along the longitudinal axis.

17. The method of claim 15, wherein the restraining step is provided by engaging a spring-loaded detent mechanism.
